(19) United States
(12) Patent Application Publication
(10) Pub. No.: US 2025/0246747 A1
(43) Pub. Date: Jul. 31, 2025

(54) EXPLOSION-PROOF VALVE INTEGRATED IN TOP COVER AND BATTERY PACK

(71) Applicant: EVE ENERGY CO., LTD., Huizhou (CN)

(72) Inventor: Hongyao Xie, Huizhou (CN)

(21) Appl. No.: 18/970,829

(22) Filed: Dec. 5, 2024

(30) Foreign Application Priority Data
Jan. 29, 2024 (CN) 202420221614.1

(51) Int. Cl. H01M 50/325

(52) U.S. Cl. CPC H01M 50/325

(57) ABSTRACT

The present disclosure relates to an explosion-proof valve integrated in a top cover and a battery pack, including: a top cover body, provided with an accommodating chamber; an explosion-proof valve body, including a pressure relief channel and a breathable film, in which the pressure relief channel and the top cover body are integrally molded, an end of the pressure relief channel is in communication with an interior of the accommodating chamber, an opposite end of the pressure relief channel is in communication with an exterior of the accommodating chamber and the breathable film is assembled to the end of the pressure relief channel.

### CROSS-REFERENCE TO RELATED APPLICATIONS

The present disclosure claims the priority of Chinese Patent Application No. 2024202216141 filed on Jan. 29, 2024 before CNIPA. All the above are hereby incorporated by reference in their entirety.

### TECHNICAL FIELD

The present disclosure relates to the technical field of explosion-proof valves and, particularly, to an explosion-proof valve integrated in a top cover and a battery pack.

### BACKGROUND

In related technologies, in order to prevent thermal runaway accidents and avoid imbalances in the internal and external pressures of the battery pack, and considering that lithium batteries may produce a large amount of toxic gases instantaneously when caught fire, it is necessary to install a pressure relief valve to discharge the gases.

In related technologies, an explosion-proof valve automatically opens when the internal pressure or temperature of the battery exceeds a limit, thereby releasing the internal pressure and ensuring the safety of the battery. Battery packs in related technologies generally adopt a separate explosion-proof valve.

Firstly, components of the separate explosion-proof valve are relatively expensive, requiring additional materials and manufacturing processes, which leads to an increase in the overall cost of the battery pack.

Secondly, the separate explosion-proof valve needs to be assembled with a top cover of the battery pack, which leads to an increase in the assembly process and complexity of the battery pack. During assembly, the sealing performance between the explosion-proof valve and the top cover needs to be ensured to prevent the internal gas of the battery pack from leaking. This requires additional processes and testing methods, which increases production costs and time.

### SUMMARY

As a first aspect, provided in the present disclosure is an explosion-proof valve integrated in a top cover, including: a top cover body, provided with an accommodating chamber; an explosion-proof valve body, including a pressure relief channel and a breathable film, in which the pressure relief channel and the top cover body are integrally molded, an end of the pressure relief channel is in communication with an interior of the accommodating chamber, an opposite end of the pressure relief channel is in communication with an exterior of the accommodating chamber and the breathable film is assembled to the end of the pressure relief channel.

As a second aspect, provided in the present disclosure is a battery pack, including a battery module, a battery box, and an explosion-proof valve integrated in a top cover. The battery module includes one or more cells and a pressure relief valve mounted on the cell, and the pressure relief valve is in communication with an end of a pressure relief channel.

1. Reduction in the number of parts: by integrating the explosion-proof valve body and the top cover body into a single unit, the number of parts is reduced and costs are lowered. This may lead to a reduction in manufacturing and assembly time and costs, and an increase in production efficiency.

2. Improvement in reliability: by integrating the explosion-proof valve body and the top cover body into a single unit, it leads to enhancement of the airtightness of the assembly between the two, to a reduction in the risk of leakage, and to an improvement in reliability. This may lead to an increase in product quality and safety, and a reduction in the costs of faults and repairs.

3. Increase in production efficiency: by integrating the explosion-proof valve body and the top cover body into a single unit, it leads to a reduction in assembly process, and to an increase in production efficiency. This may lead to a reduction in production cycle and cost, and an increase in product competitiveness.

4. Improvement in user experience: by integrating the explosion-proof valve body and the top cover body into a single unit, it leads to a reduction in volume and weight of the production, and an improvement in user experience. This may lead to a more portable and user-friendly product, thereby increasing user satisfaction.

### BRIEF DESCRIPTION OF THE DRAWINGS

FIG. 1 is a schematic structural diagram of an exterior side of the top cover body of the embodiment of the present disclosure;

FIG. 2 is a schematic structural diagram of an interior side of the top cover body of the embodiment of the present disclosure;

FIG. 3 is an enlarged schematic structural diagram of the explosion-proof valve body of the embodiment of the present disclosure;

FIG. 4 is a schematic structural diagram in a partially disassembled view of the explosion-proof valve body of the embodiment of the present disclosure; and

FIG. 5 is a schematic structural diagram in sectional view of the explosion-proof valve body of the embodiment of the present disclosure.

The meanings of the reference signs are as follows: 1 top cover body; 11 accommodating chamber; 12 opening; 13 end surface; 14 lateral surface; 15 assembly flange; 2 explosion-proof valve body; 21 pressure relief channel; 211 first channel; 212 second channel; 22 breathable film; 23 pressure relief opening; 3 reinforcing channel; 31 outflow valve; 311 support beam; 312 airflow orifice; 32 conical block; 4 stepped assembly structure.

### DETAILED DESCRIPTION

In the description of the present disclosure, it is to be noted that the terms “up”, “down”, “front”, “back”, “left”, “right”, “vertical”, “horizontal”, “top”, “bottom”, “inside”, “outside” and other orientation or position relationships are based on the orientation or position relationships shown in the attached drawings. It is only intended to facilitate description of the present disclosure and simplify description, but not to indicate or imply that the referred device or element has a specific orientation, or is constructed and operated in a specific orientation. Therefore, they should not be construed as a limitation of the present disclosure.

Unless otherwise defined, all terms including technical and scientific terms used herein have the same meaning as commonly understood by those skilled in the art to which the present disclosure belongs. The terms used herein in the specification of the present disclosure are used only to describe specific embodiments and are not intended as a limitation of the disclosure.

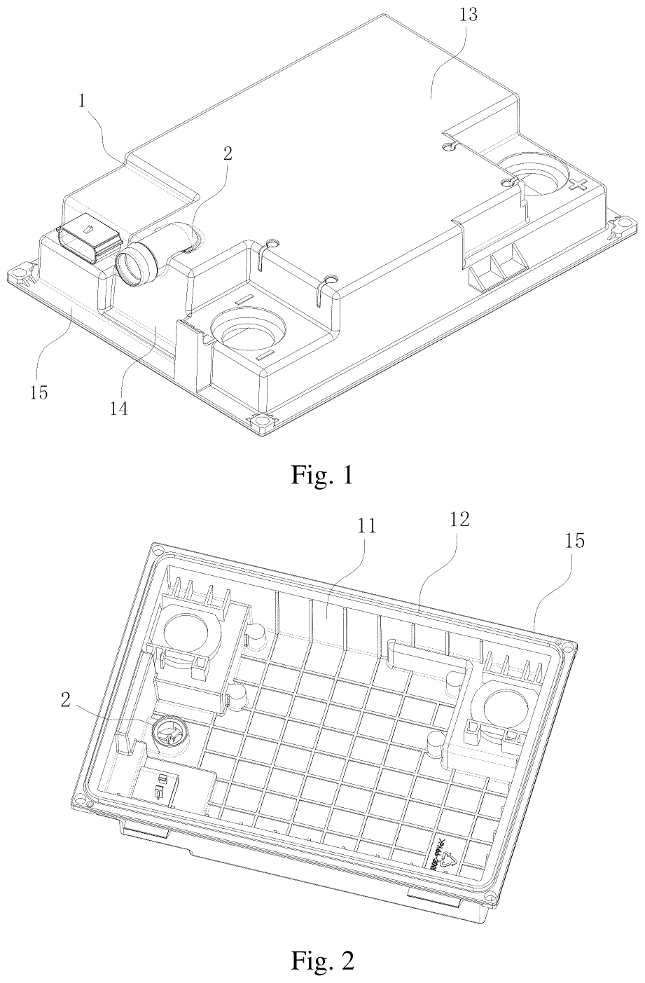

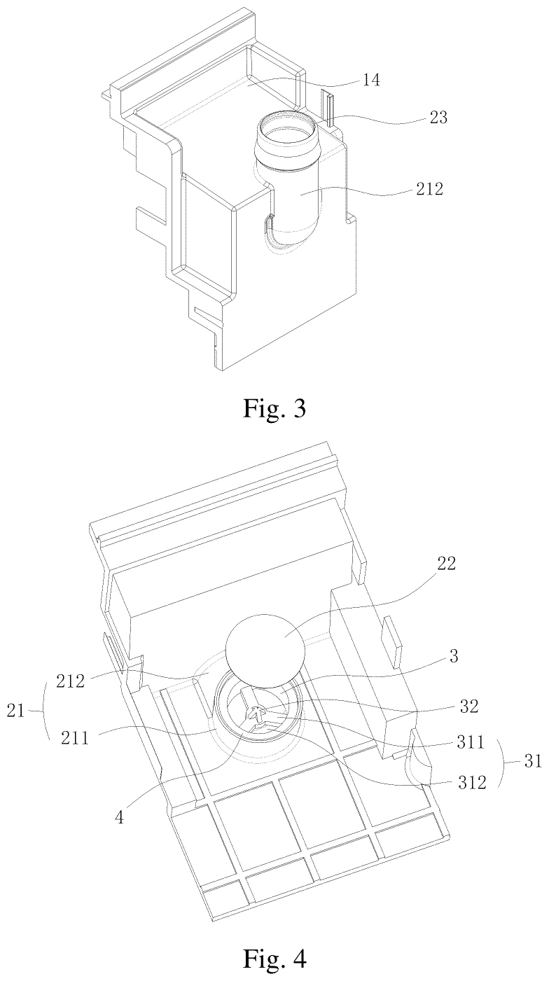

Referring to FIGS. 1-5 in embodiment of the present disclosure, disclosed is an explosion-proof valve integrated in a top cover, including a top cover body 1 and an explosion-proof valve body 2 that are integrally formed. An integral design leads to a reduction in costs, the number of the parts, and assembly process, to an increase in production efficiency. In such an arrangement, it avoids assembly airtightness problem between the two, leads to a reduction in the risk of leakage, and to an increase in reliability.

In a specific implementation, referring to FIGS. 1-2, the top cover body 1 is provided with an accommodating chamber 11, a side of the accommodating chamber 11 is open to form an opening 12, another side of the accommodating chamber 11 opposite to the opening 12 is an end surface 13 of the top cover body 1, the explosion-proof valve body 2 includes a pressure relief channel 21 and a breathable film 22. An end of the pressure relief channel 21 is in communication with an interior of the accommodating chamber 11, an opposite end of the pressure relief channel 21 is in communication with an exterior of the accommodating chamber 11, and the breathable film 22 is assembled to the end of the pressure relief channel 21. Specifically, referring to FIG. 4, the pressure relief channel 21 includes a first channel 211 and a second channel 212, the first channel 211 is vertically connected to the end surface 13, and the second channel 212 is vertically connected to the first channel 211. The second channel 212 being vertically connected to the first channel 211 may allow an airflow passing through the explosion-proof valve to be subjected to more resistance, so as to reduce the pressure of the airflow and prevent the airflow from flowing back, thereby preventing the explosive wave from propagating in an opposite direction from the explosion-proof valve. Also, a bend of 90° may lead to a reduction in the noise generated by the airflow passing through the explosion-proof valve, thereby contributing to improving the reliability of the explosion-proof valve and the safety of personnel.

Referring to FIGS. 1 and 4, the end surface 13 of the top cover body 1 is bordered with a plurality of lateral surfaces 14, the second channel 212 penetrates one of the plurality of lateral surfaces 14 that is close thereto, the second channel 212 is at least partially embedded into the lateral surface 14 close thereto, and a pressure relief opening 23 is formed by an end of the second channel 212 penetrating through the lateral surface 14 close thereto to be extended toward outside of the accommodating chamber 11. The breathable film 22 is breached when the internal pressure of the battery pack exceeds a set value, and the internal pressure of the battery pack is released through the pressure relief opening 23. In some implementations, the second channel 212 is vertically connected to the lateral surface 14. An angle between the first channel 211 and the second channel 212 may be appropriately adjusted to correspond to an angle between the lateral surface 14 and the end surface 13, thereby achieving a better fit, when the angle between the lateral surface 14 and the end surface 13 is greater than 90°. Admittedly, in other implementations, the angle between the lateral surface 14 and the end surface 13 may also not correspond to the angle between the first channel 211 and the second channel 212, and may be changed according to the actual situation, which is not specifically limited in the present embodiment.

In some implementations, referring to FIG. 4, in order to increase the pressure relief strength of the second channel 212 to prevent explosion when relieving pressure, a reinforcing channel 3 is provided in the second channel 212, the reinforcing channel 3 is at least partially extended into the first channel 211, and an end of the reinforcing channel 3 proximal to the first channel 211 is provided with an outflow valve 31. By configuring the reinforcing channel 3 to increase a thickness of the second channel 212, the second channel 212 contributes to its own strength, thereby improving the safety and reliability of the explosion-proof valve. In an implementation, the reinforcing channel 3 and the second channel 212 are integrally molded, which saves the assembly process. In other implementations, the specific assembly manner between the reinforcing channel 3 and the second channel 212 is not limited.

In order to better divert and depressurize the relief gas, in some implementations, referring to FIG. 4, the outflow valve 31 includes at least one support beam 311, and an airflow orifice 312 is formed between the support beam 311 and the reinforcing channel 3. The support beam 311 of the outflow valve 31 is configured to increase the stability and reliability of the explosion-proof valve, and is typically spliced by two intersecting metal support beams 311 or three intersecting metal support beams 311. In an implementation, provided are three support beams 311, an end of each of the three support beams 311 is connected to an axis of the reinforcing channel 3, an opposite end of each of the three support beams 311 is connected to an internal wall of the reinforcing channel 3, and the connection manner of both ends of the support beams 311 includes, but is not limited to, such as an integral connection, a welding connection, or a bonding connection. A side of a joint of the three support beams 311 facing the accommodating chamber 11 is provided with a conical block 32. A surface of the conical block 32 is provided with a flow diversion groove arranged along an axial direction of the conical block 32, and the conical block 32 is configured to control the flow rate and direction of the airflow. The velocity of the airflow increases as it passes through the conical structure, thereby reducing the pressure of the airflow. The air flow is dispersed by the air diversion groove and discharged through a plurality of airflow orifices 312, serving to reduce the air pressure. In other implementations, the number of the support beams 311 is not specifically limited, so a shape spliced by the support beams 311 includes, but is not limited to, such as a cruciform, triangle, or diamond shape.

Referring to FIG. 4, a stepped assembly structure 4 is formed between a side of the reinforcing channel 3 facing the accommodating chamber 11 and the first channel 211, and the breathable film 22 is provided on the stepped assembly structure 4, which is contributing to the assembly of the breathable film 22. In some implementations, the breathable film 22 and the stepped assembly structure 4 are connected by thermal or ultrasonic welding.

In some implementations, referring to FIGS. 1, 2, and 5, edges of the opening 12 of the accommodating chamber 11 are provided with an assembly flange 15 extending toward outside of the accommodating chamber 11. In order to allow the assembly flange 15 to serve a protective role on the pressure relief opening 23, the end of the second channel 212 penetrating through the lateral surface 14 close thereto is configured to be not project from an end of the assembly flange 15, so as to serve a protective role on the pressure relief opening of the second channel 212, which leads to a reduction in the risk of contact of the pressure relief opening 23, allowing the pressure relief opening 23 being not easily collision resulting in damage of the explosion-proof valve.

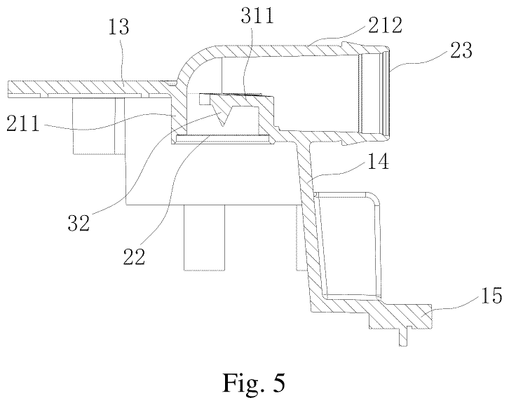

In some implementations, in order to improve the response speed and efficiency of the explosion-proof valve, an inner wall radius of the second channel 212 gradually increases in a direction away from the accommodating chamber 11. In an implementation, referring to FIG. 5, only a part of the second channel 212 close to the pressure relief opening 23 is changed in the inner wall radius, which increases a flow area of the pressure relief opening 23, thereby accelerating a release speed of the pressure and improving the response speed and efficiency of the explosion-proof valve.

Related in the present disclosure is also a battery pack, including a battery module, a battery box, and an explosion-proof valve integrated in a top cover. The battery module includes one or more cells and a pressure relief valve mounted on the cell, and the pressure relief valve is in communication with an end of the pressure relief channel 21. An integrated design of the explosion-proof valve and the top cover body 1 leads to an increase of the production efficiency of the battery pack, to a reduction in manufacturing costs and assembly process to a certain extent.

1. An explosion-proof valve integrated in a top cover, comprising:
a top cover body, provided with an accommodating chamber; and
an explosion-proof valve body, comprising a pressure relief channel and a breathable film, wherein the pressure relief channel and the top cover body are integrally molded, an end of the pressure relief channel is in communication with an interior of the accommodating chamber, an opposite end of the pressure relief channel is in communication with an exterior of the accommodating chamber, and the breathable film is assembled to the end of the pressure relief channel.

2. The explosion-proof valve integrated in a top cover according to claim 1, wherein a side of the accommodating chamber is open to form an opening, another side of the accommodating chamber opposite to the opening is an end surface of the top cover body, the pressure relief channel comprises a first channel and a second channel, the first channel is vertically connected to the end surface, and the second channel is vertically connected to the first channel.

3. The explosion-proof valve integrated in a top cover according to claim 2, wherein the end surface of the top cover body is bordered with a plurality of lateral surfaces, the second channel penetrates one of the plurality of lateral surfaces that is close thereto, the second channel is at least partially embedded into the lateral surface close thereto, and a pressure relief opening is formed by an end of the second channel penetrating through the lateral surface close thereto to be extended toward outside of the accommodating chamber.

4. The explosion-proof valve integrated in a top cover according to claim 2, wherein a reinforcing channel is provided in the second channel, the reinforcing channel is at least partially extended into the first channel, and an end of the reinforcing channel proximal to the first channel is provided with an outflow valve.

5. The explosion-proof valve integrated in a top cover according to claim 4, wherein the outflow valve comprises at least one support beam, and an airflow orifice is formed between the support beam and the reinforcing channel.

6. The explosion-proof valve integrated in a top cover according to claim 5, wherein the outflow valve comprises three support beams.

7. The explosion-proof valve integrated in a top cover according to claim 6, wherein an end of each of the three support beams is connected to an axis of the reinforcing channel, an opposite end of each of the three support beams is connected to an internal wall of the reinforcing channel.

8. The explosion-proof valve integrated in a top cover according to claim 7, wherein a connection manner of both ends of the support beams is an integral connection.

9. The explosion-proof valve integrated in a top cover according to claim 5, wherein a side of the support beam facing the accommodating chamber is provided with a conical block.

10. The explosion-proof valve integrated in a top cover according to claim 9, wherein a surface of the conical block is provided with a flow diversion groove arranged along an axial direction of the conical block.

11. The explosion-proof valve integrated in a top cover according to claim 4, wherein a stepped assembly structure is formed between a side of the reinforcing channel facing the accommodating chamber and the first channel, and the breathable film is provided on the stepped assembly structure.

12. The explosion-proof valve integrated in a top cover according to claim 11, wherein the breathable film and the stepped assembly structure are connected by thermal or ultrasonic welding.

13. The explosion-proof valve integrated in a top cover according to claim 3, wherein edges of the opening of the accommodating chamber are provided with an assembly flange extending toward outside of the accommodating chamber, and the end of the second channel penetrating through the lateral surface close thereto does not project from an end of the assembly flange.

14. The explosion-proof valve integrated in a top cover according to claim 2, wherein an inner wall radius of the second channel gradually increases in a direction away from the accommodating chamber.

15. A battery pack, comprising a battery module, a battery box, and an explosion-proof valve integrated in a top cover,
wherein the explosion-proof valve integrated in a top cover comprises:
a top cover body, provided with an accommodating chamber; and
an explosion-proof valve body, comprising a pressure relief channel and a breathable film, wherein the pressure relief channel and the top cover body are integrally molded, an end of the pressure relief channel is in communication with an interior of the accommodating chamber, an opposite end of the pressure relief channel is in communication with an exterior of the accommodating chamber, and the breathable film is assembled to the end of the pressure relief channel;
wherein the battery module comprises one or more cells and a pressure relief valve assembled to the cells, and the pressure relief valve is in communication with an end of the pressure relief channel.

16. The battery pack according to claim 15, wherein a side of the accommodating chamber is open to form an opening, another side of the accommodating chamber opposite to the opening is an end surface of the top cover body, the pressure relief channel comprises a first channel and a second channel, the first channel is vertically connected to the end surface, and the second channel is vertically connected to the first channel.

17. The battery pack according to claim 16, wherein the end surface of the top cover body is bordered with a plurality of lateral surfaces, the second channel penetrates one of the plurality of lateral surfaces that is close thereto, the second channel is at least partially embedded into the lateral surface close thereto, and a pressure relief opening is formed by an end of the second channel penetrating through the lateral surface close thereto to be extended toward outside of the accommodating chamber.

18. The battery pack according to claim 16, wherein a reinforcing channel is provided in the second channel, the reinforcing channel is at least partially extended into the first channel, and an end of the reinforcing channel proximal to the first channel is provided with an outflow valve.

19. The battery pack according to claim 18, wherein the outflow valve comprises at least one support beam, and an airflow orifice is formed between the support beam and the reinforcing channel.

20. The battery pack according to claim 19, wherein a side of the support beam facing the accommodating chamber is provided with a conical block.
